(19) United States
(12) Patent Application Publication
(10) Pub. No.: US 2025/0284788 A1
(43) Pub. Date: Sep. 11, 2025

(54) LOGIN VERIFICATION FOR AN APPLICATION PROGRAM

(71) Applicant: Tencent Technology (Shenzhen) Company Limited, Shenzhen (CN)

(72) Inventors: Shaoming WANG, Shenzhen (CN); Jinkun HOU, Shenzhen (CN); Runzeng GUO, Shenzhen (CN)

(73) Assignee: Tencent Technology (Shenzhen) Company Limited, Shenzhen (CN)

(21) Appl. No.: 19/219,833

(22) Filed: May 27, 2025

Related U.S. Application Data
(63) Continuation of application No. PCT/CN2024/085819, filed on Apr. 3, 2024.

(30) Foreign Application Priority Data
Apr. 12, 2023 (CN) 202310404019.1

(51) Int. Cl. G06F 21/32; G06F 21/45

(52) U.S. Cl. CPC G06F 21/32; G06F 21/45

(57) ABSTRACT

In a login verification method for an application program, a first biological feature of a first type of biological feature is collected to obtain a first collection result. An application interface in a login state is displayed based on the first collection result including the first biological feature being associated with a first account. The application program is logged in based on the first account in the login state. A second biological feature of a second type of biological feature is collected to obtain a second collection result. The second type of biological feature is different from the first type of biological feature. The login state of the application interface is controlled based on the second collection result.

### RELATED APPLICATIONS

The present application is a continuation of International Application No. PCT/CN2024/085819, filed on Apr. 3, 2024, which claims priority to Chinese Patent Application No. 202310404019.1, filed on Apr. 12, 2023. The entire disclosures of the prior applications are hereby incorporated by reference.

### FIELD OF THE TECHNOLOGY

This application relates to the field of information security technologies, including a login verification method for an application program.

### BACKGROUND OF THE DISCLOSURE

A scenario of application of a biological feature to electronic payment in an application program can improve convenience of payment, but also has security risks.

Payment through palm scanning is used as an example. In a scenario with a login state, for example, after a user performs a login through palm scanning, information related to the login state is temporarily buffered in a pay-by-palm terminal. Assuming that the user does not log out normally, or leaves and is not in front of a screen for a short period of time, a device having the login state of the user may be maliciously used by people, causing security-related problems.

### SUMMARY

Aspects of this disclosure include a method, an apparatus, and a non-transitory computer-readable storage medium for a login verification for an application program, which can ensure safe use in an application program having a login state.

Examples of technical solutions of this disclosure may be implemented as follows:

An aspect of this disclosure provides a login verification method for an application program. A first biological feature of a first type of biological feature is collected to obtain a first collection result. An application interface in a login state is displayed based on the first collection result including the first biological feature being associated with a first account. The application program is logged in based on the first account in the login state. A second biological feature of a second type of biological feature is collected to obtain a second collection result. The second type of biological feature is different from the first type of biological feature. The login state of the application interface is controlled based on the second collection result.

An aspect of this disclosure provides a login verification apparatus for an application program. The apparatus includes processing circuitry configured to collect a first biological feature of a first type of biological feature to obtain a first collection result. The processing circuitry is configured to display an application interface in a login state based on the first collection result including the first biological feature being associated with a first account. The application program is logged in based on the first account in the login state. The processing circuitry is configured to collect a second biological feature of a second type of biological feature to obtain a second collection result. The second type of biological feature is different from the first type of biological feature. The processing circuitry is configured to control the login state of the application interface based on the second collection result.

An aspect of this disclosure provides a non-transitory computer-readable storage medium, storing instruction which when executed by a processor cause the processor to perform a login verification method for an application program provided in the aspects of this disclosure.

Aspects of this disclosure have the following beneficial effects.

After a login is performed for an application program based on a first account bound to a first biological feature, a collection operation for a biological feature of a second type continues to be performed, and a login state of an application interface is controlled based on a second collection result. In other words, after a login is performed for the application program based on a type of biological feature, auxiliary verification is performed through another type of biological feature, so that verification channels are more comprehensive, thereby more effectively preventing user information from being maliciously used or leaked by others, further ensuring information security after a user logs into the application program.

### BRIEF DESCRIPTION OF THE DRAWINGS

FIG. 1 is a schematic diagram of an architecture of a login verification system 100 for an application program according to an aspect of this disclosure.

FIG. 2 is a schematic structural diagram of an electronic device 500 according to an aspect of this disclosure.

FIG. 3 is a schematic flowchart of a login verification method for an application program according to an aspect of this disclosure.

FIG. 4 is a schematic flowchart of a login verification method for an application program according to an aspect of this disclosure.

FIG. 5 is a schematic flowchart of a login verification method for an application program according to an aspect of this disclosure.

FIG. 6 is a schematic diagram of an application scenario of a login verification method for an application program according to an aspect of this disclosure.

FIG. 7 is a schematic diagram showing a principle of a registration and usage process according to an aspect of this disclosure.

FIG. 8 is a schematic diagram of an overall architecture of a login verification method for an application program according to an aspect of this disclosure.

FIG. 9 is a schematic flowchart of a login verification method for an application program according to an aspect of this disclosure.

FIG. 10 is a schematic diagram of an application scenario of a login verification method for an application program according to an aspect of this disclosure.

### DETAILED DESCRIPTION

To make objectives, technical solutions, and advantages of this disclosure clearer, this disclosure is to be described in further detail with reference to accompany drawings. The described aspects are not to be construed as a limitation on this disclosure. All other aspects obtained by a person of ordinary skill in the art fall within the protection scope of this disclosure. Further, the descriptions of the terms are provided as examples only and are not intended to limit the scope of the disclosure.

In the following description, a term “some aspects” involved describes subsets of all possible aspects, but “some aspects” may be the same subset or different subsets of all of the possible aspects, and may be combined with each other without conflicts.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the following description, a term “first/second/ . . . ” involved is merely used for distinguishing between similar objects and does not represent a specific order of objects. “First/second/ . . . ” may be transposed for a specific order or a sequence when allowed, so that the aspects of this disclosure described herein can be implemented in an order other than those illustrated or described herein.

In the aspects of this disclosure, a term “module” or “unit” refers to a computer program or a part of the computer program that has a predetermined function and operates together with another relevant part to achieve a predetermined goal, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in the aspects of this disclosure are the same as those usually understood by a person skilled in the art to which this disclosure belongs. Terms used in the aspects of this disclosure are merely intended to describe the objectives of the aspects of this disclosure, and are not intended to limit the aspects of this disclosure.

Before the aspects of this disclosure are described in further detail, a description is made on nouns and terms in the aspects of this disclosure, and the nouns and terms in the aspects of this disclosure are applicable to the following explanations.

1) In response to: The expression “in response to” is configured for indicating a condition or a state on which one or more to-be-performed operations depend. When the condition or the state on which the one or more to-be-performed operations depend is met, the one or more operations may be performed in real time or with a set delay. Unless otherwise specified, a sequence in which a plurality of operations are performed is not limited.

2) Biological feature: The biological feature is a physiological characteristic or a behavior manner that is unique to each living body and may be measured, or may be automatically recognized and verified. The biological feature may be divided into a physiological feature (for example, including a fingerprint, a human face, an iris, or a palm print) and a behavior feature (for example, including a gait, a voice, and handwriting). In an example, the biological feature includes a biometric feature. The biometric feature can be used for identification and/or authentication purposes.

3) Biological feature recognition: It may refer to a technology in which a computer performs personal identification through a physiological feature or a behavioral feature inherent in a living body, including palm recognition, human face recognition, fingerprint recognition, retina recognition, and the like. The palm recognition is a technology of exchanging identity information through palm multimedia information. For example, the recognition may be performed by measuring physical features of a palm and a finger of a living body. The human face recognition is a technology of exchanging identity information through human face multimedia information, and the human face recognition includes facial recognition and facial authentication.

4) Graphic code: Graphic codes are graphics bearing information, including a bar code and a two-dimensional code. The bar code is a graphic identifier that arranges a plurality of black bars and blanks having different widths according to a particular encoding rule, to express a set of information. A common bar code is a parallel line pattern formed by black bars (referred to as bars for short) and white bars (referred to as blanks for short) with great differences in reflectivity. The two-dimensional code is also referred to as a two-dimensional bar code, which is black and white graphics that record data symbol information distributed in a plane (i.e., in a two-dimensional direction) using a certain geometric shape according to a certain rule. In coding, the concepts of “0” and “1” bit streams based on computer internal logic are skillfully used, and several geometric solids corresponding to binary are used to represent literal numerical information, which may be automatically read through an image input device or a photoelectric scanning device to realize automatic information processing.

5) Operation habit: It is an operation manner that a user has developed for a long time in a process of using an application program, for example, including a clicking/tapping habit, a sliding habit, or a pressing habit. The clicking/tapping habit may be an average number of clicks/taps of the user within a set duration (for example, 2 minutes). The sliding habit may be at least one of an average sliding distance and a sliding speed when the user performs a plurality of sliding operations. The pressing habit may be an average contact area when the user performs a pressing operation, i.e., an average contact area between a finger and a screen when the user performs a plurality of pressing operations.

6) Application interface: It is an interface through which an application program interacts with a user, which includes elements that the user can see and operate. For example, the elements include a button, a text box, an icon, and an overall design and layout of the application program.

7) Specific information: It may refer to key information related to a user. If the information is obtained by an unauthorized third party, damage to account security of the user may be caused. The specific information may include personal identity information of the user, a balance of the user, a purchase record of the user, or the like.

8) Specific operation: It is an operation involving specific information in an application program. The specific operation may include an operation such as transfer, payment, balance query, or the like.

9) Login state: It usually refers to a state of a user when performing a login operation. Specifically, the login state is information configured for verifying a user identity and authorizing a system state, and usually includes information such as a login name and a password of the user. After the user performs a login successfully, the login state is stored in a system, and is configured for verifying the user identity when the user performs another operation. The login state may be in a plurality of forms, for example, including a session token, a hash value, and encrypted specific information. These methods may ensure that only an authenticated user can access a protected resource, and prevent unauthorized access and data leakage.

10) Image contrast: It refers to a degree of difference between brightness of different regions in an image. A high image contrast indicates a great difference between a bright part and a dark part in the image, so that the image is clearer and easier to observe. On the contrary, a low image contrast indicates little brightness difference between regions in the image, so that the image looks relatively blurry and unclear.

11) Definition: It refers to clarity of details and edges in an image, i.e., an information amount and details in the image. A clear image usually has clear edges and details, so that an observer can see details and structures in the image.

Aspects of this disclosure provide a login verification method and apparatus for an application program, an electronic device, a computer-readable storage medium, and a computer program product, so as to ensure safe use in an application program having a login state. The electronic device provided in the aspects of this disclosure is described below. To distinguish from a second electronic device configured to scan a graphic code, an electronic device to which a login verification method for an application program provided in the aspects of this disclosure is applied is referred to as a first electronic device. In other words, the login verification method for an application program provided in the aspects of this disclosure is applied to the first electronic device. The first electronic device provided in the aspects of this disclosure may be implemented as a terminal device, or may be implemented collaboratively by a server and a terminal device. An example in which the login verification method for an application program provided in the aspects of this disclosure is implemented collaboratively by the terminal device and the server is used for description.

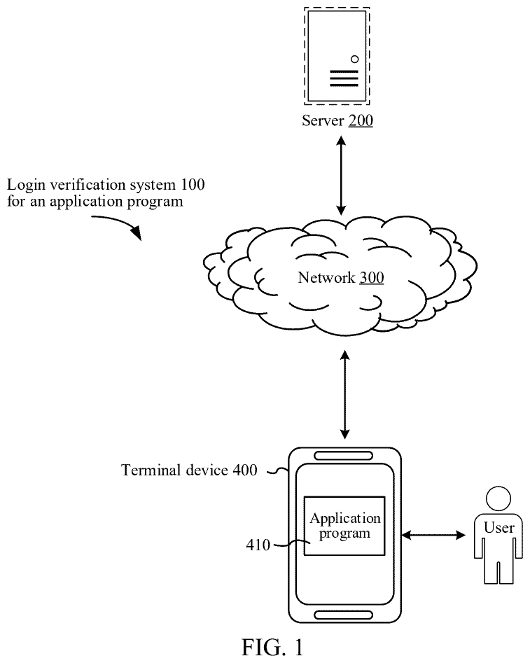

FIG. 1 is a schematic diagram of an architecture of a login verification system 100 for an application program according to an aspect of this disclosure. To implement an application that supports secure use in an application program with a login state, as shown in FIG. 1, the login verification system 100 for an application program includes a server 200, a network 300, and a terminal device 400. The network 300 may be a local area network or a wide area network, or a combination of the two. An application program 410 runs on the terminal device 400. The application program 410 may be various types of application programs. For example, when the terminal device 400 is a payment terminal, the application program 410 may be a payment application. When the terminal device 400 is a mobile phone or a tablet computer, the application program 410 may be an email application, a shopping application, or the like.

In some aspects, a payment scenario is used as an example. The terminal device 400 (for example, a payment terminal) may perform a collection operation for a biological feature (for example, a palm print feature) of a first type, to obtain a first collection result. Next, the terminal device 400 may transmit the first collection result to the server 200 through the network 300, so that the server 200 performs determination. For example, when the server 200 determines that the first collection result includes a first biological feature, and a binding relationship exists between the first biological feature and a first account, the server 200 may return the first account to the terminal device 400, so that the terminal device 400 logs into the application program 410 based on the first account. Subsequently, the terminal device 400 may further perform a collection operation for a biological feature (for example, a facial feature) of a second type, to obtain a second collection result, and control a login state of an application interface based on the second collection result. For example, when the second collection result does not include a second biological feature, the terminal device 400 may control the application interface to be switched from the login state to a non-login state. When the second collection result includes the second biological feature, and a binding relationship exists between the second biological feature and the first account, the terminal device 400 may control the application interface to maintain the login state.

The foregoing application program 410 may be a native program or a software module in an operating system, may be a native APP, i.e., a program that needs to be installed in the operating system to run, such as a payment APP or an email APP, or may be an applet, i.e., a program that only needs to be downloaded into a browser environment to run, which is not specifically limited in the aspects of this disclosure.

In some other aspects, this aspect of this disclosure may also be implemented through cloud technology. The cloud technology is a hosting technology that unifies a series of resources such as hardware, software, and a network in a wide area network or a local area network to realize data computing, storage, processing, and sharing.

The cloud technology is a generic term of a network technology, an information technology, an integration technology, a management platform technology, and an application technology based on application of a cloud computing business model. The resources may form a resource pool and are used on demand, which is flexible and convenient. A cloud computing technology is to become an important support. Background services of a technology network system require a lot of computing and storage resources.

The server 200 in FIG. 1 may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), a big data and artificial intelligence platform. The terminal device 400 may be a smart phone, a tablet computer, a notebook computer, a desktop computer, a smart speaker, a smart watch, an on-board terminal, a payment terminal (for example, including a pay-by-palm terminal or a face payment terminal), or the like, but this disclosure is not limited thereto. The terminal device 400 and the server 200 may be directly or indirectly connected in a manner of wired or wireless communication, which is not limited in this aspect of this disclosure.

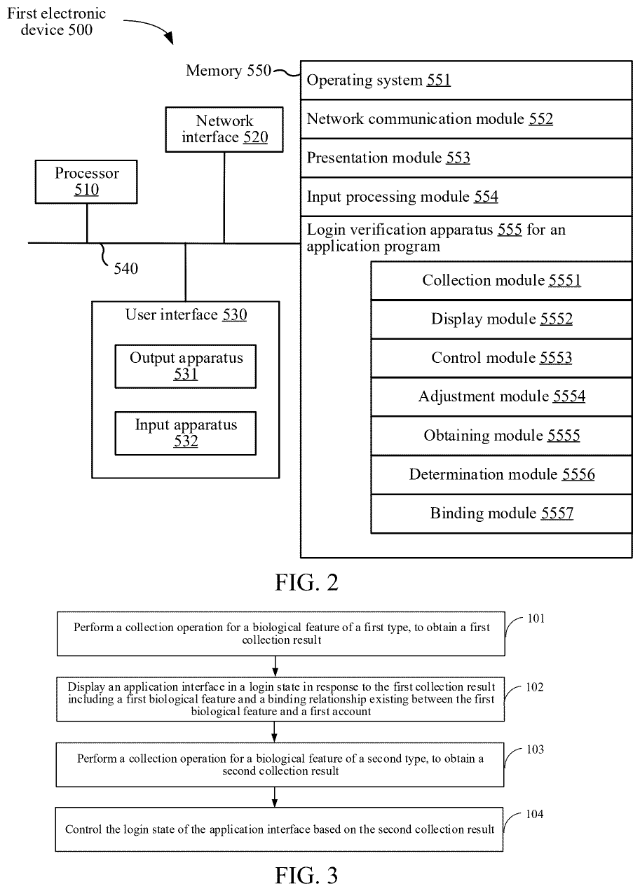

A structure of the first electronic device provided in the aspects of this disclosure continues to be described below. An example in which the first electronic device is a terminal device is used. FIG. 2 is a schematic structural diagram of a first electronic device 500 according to an aspect of this disclosure. The first electronic device 500 shown in FIG. 2 includes processing circuitry, such as at least one processor 510, a memory 550 (e.g., a non-transitory computer-readable storage medium), at least one network interface 520, and a user interface 530. Various components in the first electronic device 500 are coupled together through a bus system 540. The bus system 540 is configured to implement connection and communication between the components. In addition to a data bus, the bus system 540 further includes a power bus, a control bus, and a status signal bus. However, for clarity, various buses are marked as the bus system 540 in FIG. 2.

The processor 510 may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The user interface 530 includes one or more output apparatuses 531 that enable presentation of media content, including one or more speakers and/or one or more visual display screens. The user interface 530 further includes one or more input apparatuses 532, including user interface components that facilitate user input, such as a keyboard, a mouse, a microphone, a touch screen display, a camera, and another input button and control.

The memory 550 may be removable, non-removable, or a combination thereof. An example hardware device includes a solid-state memory, a hard disk driver, an optical disk driver, and the like. In some aspects, the memory 550 includes one or more storage devices at a physical location away from the processor 510.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in this aspect of this disclosure is intended to include any suitable type of memory.

In some aspects, the memory 550 can store data to support various operations. Examples of the data include a program, a module, and a data structure or a subset or a superset thereof. An example description is given below.

An operating system 551 includes system programs configured to process various basic system services and perform hardware-related tasks, for example, a framework layer, a core library layer, and a driver layer, which are configured for implementing various basic services and process hardware-based tasks.

A network communication module 552 is configured to reach another computing device through one or more (wired or wireless) network interfaces 520. An example network interface 520 includes a Bluetooth interface, a wireless interface such as Wi-Fi, a universal serial bus (USB) interface, and the like.

A presentation module 553 is configured to enable presentation of information (for example, a user interface for operation of a peripheral device and display of content and information) through one or more output apparatuses 531 (for example, a display screen and a speaker) associated with the user interface 530.

An input processing module 554 is configured to detect one or more user inputs or interactions from one of the one or more input apparatuses 532 and translate the detected inputs or interactions.

In some aspects, an apparatus provided in this aspect of this disclosure may be implemented by software. FIG. 2 shows a login verification apparatus 555 for an application program stored in the memory 550, which may be software in the form of programs and plug-ins, including the following software modules: a collection module 5551, a display module 5552, a control module 5553, an adjustment module 5554, an obtaining module 5555, a determination module 5556, and a binding module 5557. The modules are logical, and therefore may be arbitrarily combined or further split based on implemented functions. In FIG. 2, for convenience of expression, all the foregoing modules are shown at one time, but it is not to be deemed that the implementation in which the login verification apparatus 555 for an application program may include only the collection module 5551, the display module 5552, and the control module 5553 is excluded, and functions of the modules are to be described below.

The login verification apparatus for an application program provided in the aspects of this disclosure is to be described in further detail below in combination with an example application and implementation of the first electronic device provided in the aspects of this disclosure.

FIG. 3 is a schematic flowchart of a login verification method for an application program according to an aspect of this disclosure. A description is to be provided based on operations shown in FIG. 3.

Operation 101: Perform a collection operation for a biological feature of a first type, to obtain a first collection result. For example, a first biological feature of a first type of biological feature is collected to obtain a first collection result.

In some aspects, a login entry may be displayed on a human-machine interaction interface of the first electronic device, and operation 101 may be implemented in the following manner: performing the collection operation for the biological feature of the first type in response to a trigger operation for the login entry, to obtain the first collection result.

An example in which the first electronic device is a payment terminal, and the biological feature of the first type is a palm print feature is used. The login entry may be displayed on a screen (i.e., a human-machine interaction interface) of the payment terminal. When receiving a clicking/tapping operation performed by a user for the login entry, the payment terminal may invoke a built-in (or an external) camera to perform a collection operation for a palm print feature, so as to obtain a first collection result. For example, when receiving the clicking/tapping operation performed by the user for the login entry, the payment terminal may control a camera of a palm print recognition region to enter an on state from an off state, to perform the collection operation for the palm print feature. For example, the camera of the palm print recognition region collects an environment above the palm print recognition region to obtain the first collection result.

In some other aspects, the first electronic device may further periodically perform the collection operation for the biological feature of the first type. For example, an example in which the first electronic device is a mobile phone and the biological feature of the first type is a palm print feature is used. Before a user logs into an application program through palm scanning, the mobile phone may periodically perform the collection operation for the palm print feature. For example, the collection operation for the palm print feature is performed every 10 seconds, to ensure security.

In some aspects, the foregoing operation 101 may further be implemented by the first electronic device in the following manner: performing the collection operation for the biological feature of the first type in response to the first electronic device entering a screen-on state from a screen-off state, to obtain a first collection result.

An example in which the first electronic device is a payment terminal and the biological feature of the first type is a palm print feature is used. When a user click/taps a screen of the payment terminal in a screen-off state, the payment terminal enters a screen-on state from the screen-off state, and controls a camera of a palm print recognition region to enter an on state from an off state, to perform a collection operation for the palm print feature. In this way, the collection operation for the palm print feature is performed only when the payment terminal is in the screen-on state, which can effectively reduce resource consumption of the payment terminal.

In some other aspects, the foregoing operation 101 may further be implemented by the first electronic device in the following manner: performing the collection operation for the biological feature of the first type in response to a living body (for example, a human body) being detected and a distance between the living body and the first electronic device being less than a distance threshold, to obtain a first collection result.

An example in which the first electronic device is a notebook computer, and the first biological feature is a facial feature is used. Before a user logs into an application program through face scanning, the notebook computer may invoke a built-in (or an external) sensor (for example, a distance sensor) to detect whether a living body exists in an environment having a distance to the notebook computer less than a distance threshold (for example, 1 meter). If the living body exists, a collection operation for the facial feature is performed. For example, the notebook computer may control a built-in (or an external) camera to enter an operating state, to perform the collection operation for the facial feature. In this way, the notebook computer may still perform the collection operation for the facial feature when there is no one nearby, thereby avoiding a waste of resources of the notebook computer.

The foregoing distance threshold may be preset, or may be manually set by the user, so as to satisfy personalized requirements of different users, which is not specifically limited in the aspects of this disclosure.

Operation 102: Display an application interface in a login state in response to the first collection result including a first biological feature and a binding relationship existing between the first biological feature and a first account. For example, an application interface in a login state is displayed based on the first collection result including the first biological feature being associated with a first account. The application program is logged in based on the first account in the login state.

Herein, the first account may be a social network account (for example, a personal instant messaging account or a corporate instant messaging account). The login state is a state in which a login is performed for the application program based on the first account, and the application interface may be an interface in the application program that involves specific information (for example, a balance, a purchase record, and identity information).

In some aspects, an example in which the first electronic device is a payment terminal, and the first biological feature is a palm print feature is used. The payment terminal may invoke a camera of a palm print recognition region to collect an image of an environment, to obtain a plurality of images (i.e., a first collection result), and then perform (i.e., determine whether a palm exists in a plurality of collected images) detection processing for the palm in the plurality of collected images. When a palm (for example, assuming that a user places the palm above the palm print recognition region) is detected from the plurality of images (assuming that an image 1 to an image 10 are included), for example, it is assumed that a palm of a user is detected in all of the image 3 to the image 7, and then an optimal palm image (assuming that the optimal palm image is the image 4) may be further comprehensively selected based on coefficient indicators such as a palm size, an angle, image contrast, and brightness and definition of an image. Subsequently, the image 4 may be transmitted to a server, so that the server extracts a corresponding palm print feature from the image 4, and determines a similarity between the extracted palm print feature and each of a plurality of authorized palm print features. When a maximum similarity is greater than or equal to a similarity threshold (for example, 95%), the server may further query for an account (assuming that the account is an account 1 associated with a user A) to which the maximum similarity corresponds and the authorized palm print feature is bound, to serve as the first account (i.e., the currently collected palm print feature is a palm print feature of the user A). Subsequently, the server may perform encryption processing through a data encryption standard (DES) based on a random number, the account 1, and a current timestamp, so as to obtain a token, and return the token to the payment terminal, so that the payment terminal logs into an application program (for example, a pay-by-palm APP) running on the payment terminal based on the account 1 carried in the token.

Each time the payment terminal subsequently transmits a request to the server, the token needs to be carried to prove the identity of the user A. In addition, the token may have a certain expiry date, i.e., a temporary token. After the expiry date, the server generates a new token, and transmits the new token to the payment terminal. Moreover, when the server determines that the maximum similarity is less than the similarity threshold, it indicates that the currently collected palm print feature does not belong to any authorized user, and the server may transmit a corresponding notification message to the payment terminal, so as to display prompt information on the screen of the payment terminal, to prompt that the user needs to collect the palm print feature again.

In addition, in addition to network verification, local verification may further be adopted. For example, when the first electronic device locally stores a plurality of authorized biological features of the first type, the first biological feature may be matched with a plurality of locally stored authorized biological features, which is not specifically limited in the aspects of this disclosure.

In some other aspects, when the first collection result does not include the first biological feature, prompt information may be displayed on the human-machine interaction interface of the first electronic device, so as to prompt that the collection operation for the biological feature of the first type needs to be performed again. For example, an example in which the biological feature of the first type is a palm print feature is used. The following prompt information may be displayed on the human-machine interaction interface of the first electronic device: please reposition your palm over the palm print recognition region.

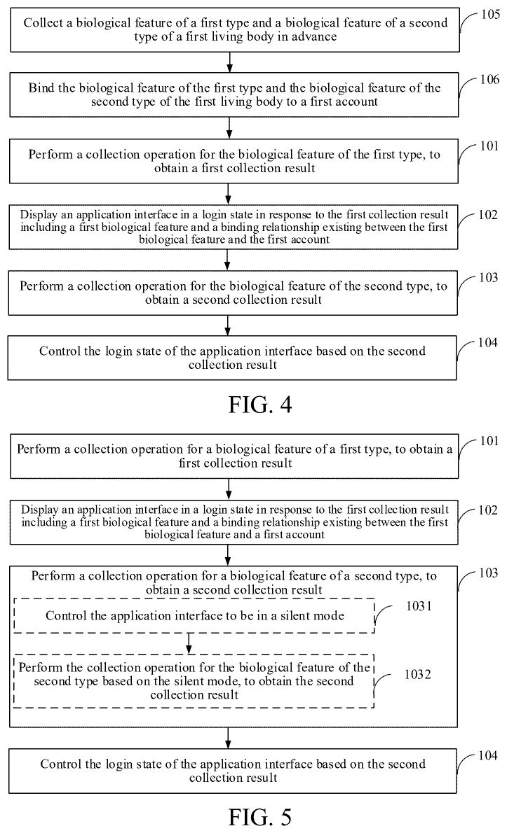

In some aspects, an example in which the first account is an account associated with a first living body is used. FIG. 4 is a schematic flowchart of a login verification method for an application program according to an aspect of this disclosure. As shown in FIG. 4, before operation 101 shown in FIG. 3 is performed, operation 105 and operation 106 shown in FIG. 4 may be further performed. A description is to be provided based on operations shown in FIG. 4.

In operation 105, a biological feature of a first type and a biological feature of a second type of a first living body are collected in advance. For example, the first biological feature and the second biological feature for a first user are collected.

In some aspects, an example in which the biological feature of the first type is a palm print feature, the biological feature of the second type is a facial feature, the first electronic device is a payment terminal, and the first living body is a user A is used. Before using a palm-scan login function, the user first registers, i.e., the payment terminal needs to collect a palm print feature and a facial feature of the user A in advance as authorized biological features.

In operation 106, the biological feature of the first type and the biological feature of the second type of the first living body are bound to a first account. For example, the first biological feature and the second biological feature are bound to the first account. The first account is associated with the first user.

In some aspects, carrying with the foregoing examples, after collecting the palm print feature and the facial feature of the user A, the payment terminal may bind the collected palm print feature and facial feature to an account (i.e., a first account, such as a social network account registered by the user A) associated with the user A.

In addition to a pay-by-palm APP, the foregoing application program may further be another type of application program, for example, an email APP and a shopping APP, which is not specifically limited in the aspects of this disclosure.

In operation 103, a collection operation for the biological feature of the second type is performed, to obtain a second collection result. For example, a second biological feature of a second type of biological feature is collected to obtain a second collection result. The second type of biological feature is different from the first type of biological feature.

Herein, the biological feature of the second type is different from the biological feature of the first type. For example, the biological feature of the first type may be one of a palm print feature and a facial feature, and the biological feature of the second type is the other of the palm print feature and the facial feature. For example, assuming that the biological feature of the first type is the palm print feature, the biological feature of the second type is the facial feature.

In addition to the palm print feature and the facial feature, the biological feature of the first type (or the biological feature of the second type) may further be another biological feature, for example, a voice print feature or an iris feature. For example, the biological feature of the first type may be the voice print feature, and the biological feature of the second type may be the iris feature, which is not specifically limited in the aspects of this disclosure.

In some aspects, the first electronic device may periodically perform the collection operation for the biological feature of the second type. For example, the first electronic device may perform the collection operation for the biological feature of the second type every 1 minute. The first electronic device may also perform the collection operation for the biological feature of the second type when detecting that a duration for which a user has not operated is greater than a duration threshold (i.e., 2 minutes). For example, assuming that the first electronic device has not received any operation triggered by the user within 2 minutes after an application interface in a login state is displayed, the first electronic device may perform the collection operation for the biological feature of the second type, thereby preventing a device having the login state of the user from being maliciously used by people as a result of the user briefly leaving the screen.

In some other aspects, the first electronic device may also perform the collection operation for the biological feature of the second type when detecting that the user performs a specific operation (for example, a balance query operation, a transfer operation, or a payment operation) on the application interface. For example, an example in which the first electronic device is a payment terminal, and the biological feature of the second type is a facial feature is used. When detecting that a user has performed a transfer operation on an application interface, the payment terminal may invoke a built-in (or an external) camera to collect a human face image of the user in front of the screen, so as to determine whether a same person is presented. In other words, when it is detected that a user has not performed a specific operation involving important personal information (i.e., specific information) of the user on the application interface, the collection operation for the biological feature of the second type may not be performed, so as to save resource overheads of the first electronic device.

In some aspects, it may be further determined, based on an operation habit of the user, whether the same person is presented. The collection operation for the biological feature of the second type is performed only when it is determined that a different person is presented. Before performing the foregoing operation 103, the first electronic device may further perform the following processing: obtaining operation data in a current time period (for example, assuming that the time period is between the 3rd minute and the 4th minute after a login to an application program) and operation data in a previous time period (for example, assuming that the time period is within 1 minute after the login to the application program); performing feature extraction on the operation data in the current time period and the operation data in the previous time period separately, to correspondingly obtain a feature of the operation data in the current time period and a feature of the operation data in the previous time period; and then invoking a machine learning model to perform prediction processing based on the feature of the operation data in the current time period and the feature of the operation data in the previous time period, to determine whether a same living body is presented. For example, the machine learning model may calculate a similarity between the feature of the operation data in the current time period and the feature of the operation data in the previous time period (for example, calculate a Euclidean distance between two feature vectors). When the similarity is less than a similarity threshold, a determining result of not the same living body being presented is outputted. In this case, the first electronic device performs the collection operation for the biological feature of the second type.

The foregoing operation data may include at least one of the following: a number of clicks/taps of a user, at least one of a sliding distance and a sliding speed when a user performs a sliding operation, and a contact area when the user performs a pressing operation.

An example in which the first electronic device is a payment terminal, the biological feature of the first type is a palm print feature, and the biological feature of the second type is a facial feature is used. Assuming that a user (for example, a user A) logs into an application program (for example, a pay-by-palm APP) running on the payment terminal through palm scanning at 10:00, and assuming that a current moment is 10:03, the payment terminal may further obtain operation data of an operation performed by a user (which may be the user A or another user) on the payment terminal in a current time period (for example, 10:03 to 10:04), and operation data of an operation performed by a user (i.e., the user A) on the payment terminal in a previous time period (for example, 10:00 to 10:01), and respectively perform feature extraction processing on the operation data in the two time periods, so as to correspondingly obtain the feature of the operation data in the current time period and the feature of the operation data in the previous time period. Subsequently, the machine learning model may be invoked, based on the feature of the operation data in the current time period and the feature of the operation data in the previous time period, to perform prediction processing, so that the machine learning model outputs a determining result of whether a same user is presented. When the determining result outputted by the machine learning model is that the same user is presented, i.e., the user operating on the payment terminal in the current time period and the user operating on the payment terminal in the previous time period are not the same user, the payment terminal may perform a collection operation for the facial feature, to perform further verification.

The foregoing machine learning model may be trained based on operation data of sample users in different time periods. In addition, an example structure of the machine learning model may include an input layer (i.e., an embedding layer), an encoding layer (which may be for example formed by a plurality of cascaded convolutional layers), a fully connected layer, and an output layer (including an activation function such as a Softmax function). For example, the operation data in the current time period and the operation data in the previous time period may be inputted into the input layer for embedding processing. Then, encoding processing is performed on an embedding feature vector outputted by the input layer through the encoding layer, to obtain a hidden layer feature vector. Subsequently, the hidden layer feature vector is fully connected through the fully connected layer. Finally, a full connection result outputted by the fully connected layer is inputted into the output layer, to perform activation processing through the output layer, so as to obtain a determining result of whether the same user is presented.

The machine learning model may be a neural network model (for example, a convolutional neural network, a deep convolutional neural network, or a fully connected neural network), a decision tree model, a gradient lifting tree, a multi-layer perceptron, a support vector machine, and the like. The type of the machine learning model is not specifically limited in this aspect of this disclosure.

In some other aspects, it may also be determined based on a rule whether the same user is presented. For example, after obtaining the operation data in the current time period, the operation data in the current time period may be compared with the operation data in the previous time period. When a difference between the operation data in the current time period and the operation data in the previous time period is greater than a difference threshold (for example, assuming that a sliding distance (assumed to be 3 centimeters) of a sliding operation included in the operation data in the current time period is significantly greater than a sliding distance (assumed to be only 1 centimeter) of a sliding operation included in the operation data in the previous time period, or assuming that a contact area (assumed to be 0.5 square centimeters) included in the operation data in the current time period is significantly less than a contact area (assumed to be 1.5 square centimeters) included in the operation data in the previous time period), it indicates that different users are presented in the two time periods. Then the payment terminal may perform the collection operation for the facial feature to perform further verification, which is not specifically limited in the aspects of this disclosure.

In some aspects, FIG. 5 is a schematic flowchart of a login verification method for an application program according to an aspect of this disclosure. As shown in FIG. 5, operation 103 shown in FIG. 3 may be implemented through operation 1031 to operation 1032 shown in FIG. 5. A description is to be provided based on operations shown in FIG. 5.

In operation 1031, an application interface is controlled to be in a silent mode. For example, a silent mode is enabled on the application interface related to collecting the second biological feature.

Herein, the silent mode is configured for shielding an output of a prompt (for example, including a vibration, a sound, or an image) related to a collection operation for a biological feature of a second type.

In operation 1032, a collection operation for the biological feature of the second type is performed based on the silent mode, to obtain a second collection result. For example, the second biological feature in the silent mode is collected.

In some aspects, an example in which a first electronic device is a payment terminal, and the biological feature of the second type is a facial feature is used. The payment terminal may perform a collection operation for the facial feature based on the silent mode, to obtain a second collection result. For example, when performing the collection operation for the facial feature, the payment terminal does not display a currently collected human face image on a screen in real time. In other words, the payment terminal may silently perform the collection operation for the facial feature in the background, so as not to interfere with a process in which a user performs a related operation on an application interface, thereby improving user experience.

In operation 104, a login state of the application interface is controlled based on a second collection result. For example, the login state of the application interface is controlled based on the second collection result.

In some aspects, operation 104 may be implemented in the following manner: controlling, in response to the second collection result including a second biological feature and a binding relationship existing between the second biological feature and the first account, the application interface to maintain the login state.

An example in which the biological feature of the second type is the facial feature is used. The first electronic device may invoke a built-in (or an external) camera to perform an image collection on an environment in front of the first electronic device, to obtain a plurality of images (i.e., a second collection result), and then may perform detection processing on a human face (i.e., detect whether a human face exists in a plurality of collected images) for the plurality of images (including an image 1 to an image 10). Assuming that a human face is detected from the plurality of images, for example, assuming that a human face is detected in all of the image 2 to the image 9, an optimal human face image (assumed to be an image 5) may be further comprehensively selected based on coefficient indicators such as a human face size, an angle, image contrast, and brightness and definition of an image. Subsequently, the first electronic device may transmit the image 5 to a server, so that the server extracts a corresponding facial feature from the image 5, and matches the extracted facial feature with a plurality of authorized facial features stored in the server in advance. When a maximum similarity is greater than a similarity threshold, an account bound to an authorized facial feature corresponding to the maximum similarity is queried. If the found account is the first account, it is determined that a same user is presented. The server may transmit a notification message of maintaining a login state to the first electronic device, so that the first electronic device controls an application interface to maintain the login state.

In some other aspects, operation 104 described above may further be implemented in the following manner: switching the application interface from the login state to a non-login state in response to the second collection result including the second biological feature and no binding relationship existing between the second biological feature and the first account, the non-login state being a state in which a login is not performed for the application program based on the first account.

An example in which the second biological feature is a facial feature is used. When a second collection result includes a facial feature, but no binding relationship exists between the facial feature and the first account, for example, assuming that the currently collected facial feature is bound to a second account, it indicates that a different user is presented. Then the first electronic device may directly switch an application interface from a login state to a non-login state, thereby preventing information of the user from being leaked or maliciously used by others.

In some aspects, when it is determined that a different person is presented, further verification may be further performed. A logout from the login state is performed only when the verification fails. The foregoing switching the application interface from the login state to a non-login state in response to the second collection result including the second biological feature and no binding relationship existing between the second biological feature and the first account may be implemented in the following manner: switching the application interface from the login state to the non-login state; displaying prompt information in response to the second collection result including the second biological feature and no binding relationship existing between the second biological feature and the first account, the prompt information being configured for prompting that verification needs to be performed based on the biological feature of the first type; performing the collection operation for the biological feature of the first type again, to obtain a third collection result; and determining, in response to the third collection result not including the first biological feature, that the verification fails, and switching the application interface from the login state to the non-login state.

An example in which the biological feature of the first type is a palm print feature, the biological feature of the second type is a facial feature, and the first electronic device is a payment terminal is used. When a server determines that no binding relationship exists between the currently collected facial feature and the first account, i.e., determines that a different person is presented (for example, the palm print feature is a palm print feature of a user A, and the facial feature is a facial feature of a user B), the server may transmit a corresponding notification message to the payment terminal, so that the payment terminal displays prompt information indicating that palm scanning verification needs to be performed again on a human-machine interaction interface, for example, “Palm scanning needed again for verification”. Subsequently, the payment terminal may perform a collection operation for a palm print feature again, to obtain a third collection result. When the third collection result does not include the palm print feature (or a palm print feature exists, but the palm print feature is not the palm print feature of the user A), it is determined that the verification fails. The payment terminal may switch the application interface from the login state to the non-login state, thereby preventing information of the user from being leaked or maliciously used by others.

In some other aspects, carrying on with the foregoing example, when the third collection result includes a first biological feature (for example, the palm print feature of the user A), it indicates that the user A is still in front of the screen of the payment terminal, and it is determined that the verification succeeds. The payment terminal may control the application interface to maintain the login state. In this way, when it is determined based on the facial feature that a different person is presented, further verification is performed based on the palm print feature, so as to avoid mistakenly considering that a different person is presented due to factors such as a photographing angle, and then a logout from the login state is performed, which affects normal operation of the user.

In some aspects, when no binding relationship exists between the second biological feature and the first account, i.e., it is determined that the different user is presented, the first electronic device may further perform the following processing: displaying a graphic code (for example, a two-dimensional code); receiving configuration information transmitted by the second electronic device (for example, a mobile phone or a tablet computer) after scanning the graphic code; and performing one of the following processes based on the configuration information: adjusting a frequency at which the collection operation is performed for the biological feature of the second type; displaying a time interval between a current moment and a next time for performing the collection operation for the biological feature of the second type; and restoring the frequency at which the collection operation is performed for the biological feature of the second type to a default frequency.

In some other aspects, carrying on with the foregoing example, the first electronic device may further perform the following processing: suspending a business process on the application interface in response to the graphic code being scanned; and restoring the business process on the application interface in response to the configuration information transmitted by the second electronic device having been received.

An example in which the first electronic device is a payment terminal, and the second electronic device is a mobile phone is used. When it is determined that a different person is presented (namely, no binding relationship exists between the second biological feature and a first account), a two-dimensional code may be displayed on a human-machine interaction interface of the payment terminal for the user to scan. When the payment terminal detects that the two-dimensional code has been scanned, a waiting interface may be displayed to suspend a business process on the application interface. Subsequently, after the payment terminal receives configuration information transmitted by the mobile phone of the user, the display of the waiting interface may be canceled, to restore the business process on the application interface.

In some aspects, the foregoing graphic code may include an identifier of the first electronic device, for example, a character string serial number (SN), which is configured for the second electronic device to perform the following processing: displaying a setting interface corresponding to the first electronic device based on the identifier, the setting interface including a sensitivity setting control; and displaying a sensitivity setting interface in response to a trigger operation for the sensitivity setting control, the sensitivity setting interface including at least one of the following controls: a time interval control, configured to adjust a frequency at which the first electronic device performs the collection operation for the biological feature of the second type; a visualization control, configured to display, in the first electronic device, a time interval between a current moment and a next time for performing the collection operation for the biological feature of the second type; and a default configuration restoring control, configured to restore, to the default frequency, the frequency at which the first electronic device performs the collection operation for the biological feature of the second type.

An example in which the first electronic device is a payment terminal, and the second electronic device is a mobile phone is used. A two-dimensional code displayed on the screen of the payment terminal may carry an identifier of the payment terminal. When a user scans the two-dimensional code displayed on the payment terminal through the mobile phone, a setting interface corresponding to a current payment terminal, i.e., a setting interface configured to set the current payment terminal, may be displayed on the mobile phone based on the identifier carried in the two-dimensional code. The sensitivity setting control may be displayed on the setting interface. When a clicking/tapping operation performed by the user for the sensitivity setting control is received, the setting interface may jump to the sensitivity setting interface. The time interval control, the visualization control, and the default configuration restoring control may be displayed on the sensitivity setting interface.

For example, when the mobile phone of the user receives a clicking/tapping operation performed by a user on the time interval control, a pop-up window may be displayed. A plurality of candidate frequencies are displayed in the pop-up window, for example, including a frequency 1 to a frequency 5. When the user selects the frequency 2 in the pop-up window, the mobile phone of the user may transmit corresponding configuration information to the payment terminal through a server (for example, the configuration information may carry the frequency 2 selected by the user), so that the payment terminal adjusts, to the frequency 2 (for example, the collection operation is performed every 30 seconds), a frequency at which the collection operation for the biological feature of the second type (for example, the facial feature) is performed.

For example, when the mobile phone of the user receives a clicking/tapping operation performed by the user for the visualization control, the mobile phone of the user may transmit corresponding configuration information (for example, the configuration information may carry a notification message displaying a time interval) to the payment terminal through a server, so that the payment terminal displays a floating window on the screen. A time interval between a current moment and a next time for performing the collection operation for the biological feature of the second type is displayed in the floating window, for example, “10 seconds left before the next time for performing the collection operation for the facial feature”, so as to allow the user to prepare in advance for the collection of the facial feature.

For example, when the mobile phone of the user receives a clicking/tapping operation of the user for the default configuration restoring control, the mobile phone of the user may transmit corresponding configuration information (for example, the configuration information may carry a notification message indicating restoration to a default frequency) to the payment terminal through a server, so that the payment terminal restores, to the default frequency, the frequency at which the collection operation for the biological feature of the second type is performed.

In some aspects, carrying on with the foregoing example, before performing the collection operation for the biological feature of the second type, the first electronic device may further perform the following processing: determining, in response to a biological feature protection function in the second electronic device being in an enabled state, that the collection operation for the biological feature of the second type is to be performed, the biological feature protection function being configured for controlling the login state of the application interface based on the biological feature of the second type.

An example in which the biological feature of the second type is a facial feature, the first electronic device is a payment terminal, and the second electronic device is a mobile phone is used. A control entry may be set on the mobile phone, and a user may enable or disable a human face security protection function. When the user enables the human face security protection function on the mobile phone, the payment terminal performs a collection operation for the facial feature. When the user disables the human face security protection function on the mobile phone, the payment terminal does not perform the collection operation for the facial feature. In this way, the user may easily determine whether the human face security protection function is enabled.

In some other aspects, after obtaining the second collection result, the first electronic device may further detect a distance between the user and the first electronic device in the second collection result through depth information of an image. If the distance is greater than a distance threshold, it indicates that a person behind is collected, and the collection needs to be performed again. In other words, the first electronic device may further perform the following processing: obtaining a first distance and a second distance, the first distance being a distance between a living body corresponding to the first biological feature and the first electronic device, and the second distance being a distance between a living body corresponding to the second biological feature and the first electronic device; and performing the collection operation for the biological feature of the second type again in response to a difference between the second distance and the first distance being greater than a difference threshold (for example, 0.2 meters).

An example in which the first biological feature is a palm print feature, the second biological feature is a facial feature, and the first electronic device is a payment terminal is used. When performing a collection operation for the palm print feature, the payment terminal may further invoke a depth sensor (for example, an infrared ranging sensor) to detect a distance (i.e., a first distance) between a user and the payment terminal. Similarly, the payment terminal may also invoke the infrared ranging sensor to detect a distance (i.e., a second distance) between the user and the payment terminal when performing a collection operation for the facial feature. When a difference between the two distances is greater than a difference threshold, it indicates that a facial feature of a person behind is collected, and a corresponding prompt message may be displayed on the payment terminal, to prompt the user that the facial feature needs to be collected again. In this way, a subsequent unnecessary verification process may be directly omitted, thereby effectively reducing resource consumption of the payment terminal.

In some other aspects, operation 104 described above may further be implemented in the following manner: switching the application interface from the login state to the non-login state in response to the second collection result not including a second biological feature.

An example in which the second biological feature is a facial feature is used. When the second collection result does not include the facial feature, for example, no human face is detected in a plurality of images captured by the first electronic device invoking a built-in camera, it indicates that the user has left the screen of the first electronic device. To avoid malicious use of user information by others, the first electronic device may switch an application interface from a login state to a non-login state to ensure information security of the user.

According to the login verification method for an application program provided in the aspects of this disclosure, after a login is performed for the application program based on the first account bound to the first biological feature, the collection operation for the biological feature of the second type continues to be performed, and the login state of the application interface is controlled based on the second collection result. In this way, after a login is performed for the application program based on the first biological feature, continuous verification is performed through the biological feature of the second type, so as to effectively avoid malicious use or leakage of user information by others, thereby ensuring security of the user information.

Next, an example application of the aspects of this disclosure in an actual application scenario is described by using a payment scenario as an example.

After a user logs into an applet through palm scanning on an offline public palm-face payment terminal, to avoid an account security problem caused by a residual login state as a result of the user leaving, identity verification needs to be continuously performed after login. However, continuous palm lifting is a poor user experience.

In view of this, the aspects of this disclosure provides a login verification method for an application program. When a user registers with a palm scanning application (for example, an applet), the user is advised to bind information related to a human face at the same time. In this way, based on a binding relationship between a palm (corresponding to the foregoing biological feature of the first type) and a human face (corresponding to the foregoing biological feature of the second type) of the user, when the user subsequently logs into a related application through palm scanning offline, the human face may be used for silent recognition based on a fact that the human face is positioned in front of a device for a relatively long period of time, to determine whether a same person is presented to ensure information security of the user.

The login verification method for an application program provided in the aspects of this disclosure is described in further detail below.

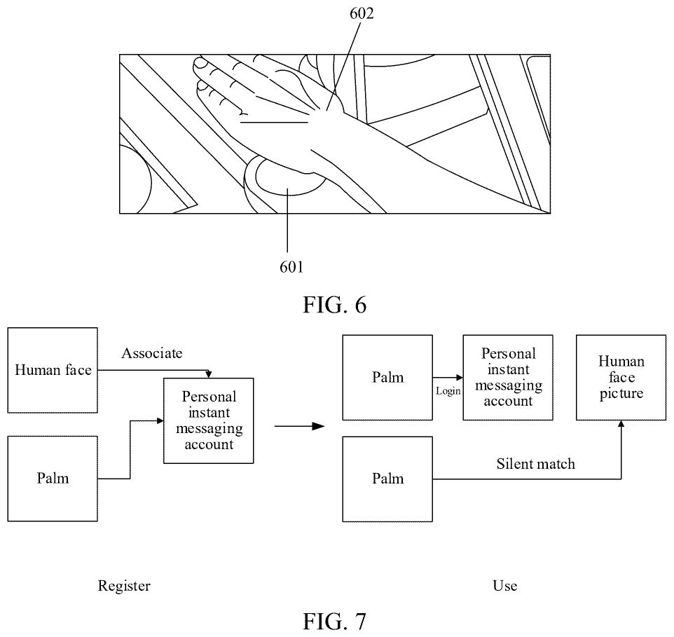

In some aspects, FIG. 6 is a schematic diagram of an application scenario of a login verification method for an application program according to an aspect of this disclosure. As shown in FIG. 6, the login verification method for an application program according to an aspect of this disclosure may be applied to a pay-by-palm scenario. A user may log in to an applet through palm scanning. For example, the user may place a palm 602 above a palm print recognition region 601, so that a pay-by-palm terminal collects a palm 602 of the user, so as to obtain a palm image of the user. Then, a corresponding palm print feature may be extracted from the palm image. Subsequently, the extracted palm print feature may be matched with a plurality of authorized palm print features, to obtain identity information (for example, an instant messaging account associated with the user) of the user. Finally, a login may be performed for the applet based on the obtained instant messaging account.

In some other aspects, FIG. 7 is a schematic diagram of a principle of a registration and usage process according to an aspect of this disclosure. As shown in FIG. 7, the login verification method for an application program provided in this aspect of this disclosure includes a registration stage and a usage stage. For the registration stage, when a user needs to register a palm-bound social network account (for example, an instant messaging account) in an early stage, the user is advised to bind human face information of the user. The human face information is bound to only a palm-related application. For the usage stage, after the user uses pay-by-palm payment offline and performs a login through palm scanning, human face information bound to the palm is detected in real time to perform real-time silent recognition, and the process may continue only when the same person is presented. In addition, a control entry may further be set on a mobile phone terminal (corresponding to the foregoing second electronic device), and the user may enable or disable a human face security protection function first. In other words, only after the user enables the human face security protection function on the mobile phone terminal and performs a login through palm scanning, the human face information bound to the palm is detected in real time to perform real-time silent recognition.

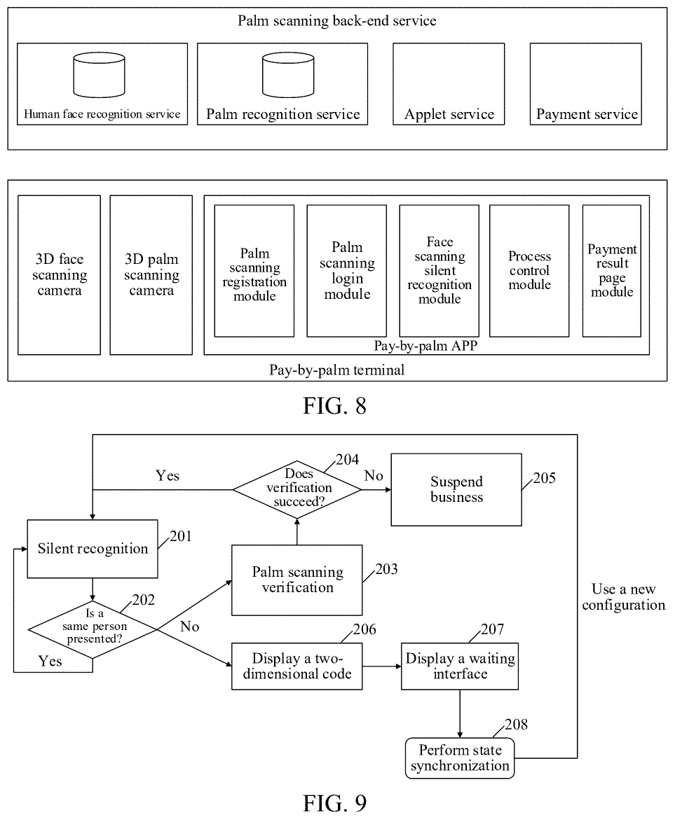

In some aspects, FIG. 8 is a schematic diagram of an overall architecture of a login verification method for an application program according to an aspect of this disclosure. As shown in FIG. 8, the overall architecture of the login verification method for an application program according to this aspect of this disclosure includes a pay-by-palm terminal (corresponding to the foregoing first electronic device) and a palm scanning back-end service. The pay-by-palm terminal is first described below.

The pay-by-palm terminal is mainly configured to perform businesses related to pay-by-palm and login, and has two cameras including a three-dimensional (3D) palm scanning camera and a 3D face scanning camera as the core. The 3D palm scanning camera is configured to support palm scanning-related service, and the 3D face camera is configured to only assist recognition to confirm user identity. In addition, a pay-by-palm APP runs on the pay-by-palm terminal. The pay-by-palm APP includes a palm scanning registration module, a palm scanning login module, a face scanning silent recognition module, a process control module, and a payment result page module.

Palm collection and recognition are used as an example. The pay-by-palm APP may invoke a 3D scanning palm camera to collect current palm streaming media data of a user. After obtaining the streaming media data, the pay-by-palm terminal may perform optimization selection for the streaming media data. For example, an optimal palm image may be comprehensively selected through coefficient indicators such as a palm size, an angle, image contrast, and brightness and definition of an image. Subsequently, the pay-by-palm terminal may transmit the preferred palm image to the palm scanning back-end service for palm recognition, to further obtain related information such as user identity information (for example, an instant messaging account) or a payment code corresponding to the palm.

A process of human face collection and recognition is similar to a process of palm collection and recognition, and details are not described herein again in the aspects of this disclosure.

The palm scanning registration module in the pay-by-palm APP continues to be described below.

In some aspects, before using a palm scanning-related application, a user needs to bind a palm to an instant messaging account in advance. A specific process is as follows: A user first scans a palm, and since the user has not registered yet, the user is prompted as a new user, and needs to scan a barcode to register and open an account. Subsequently, a pay-by-palm terminal displays a palm scanning applet code. The applet code is associated with a palm image identified and uploaded by the current user in advance. After scanning the barcode through a mobile phone, the user enters an applet of a mobile phone terminal. an applet side of the mobile phone obtains a current user identity (for example, an instant messaging account), and asks the user whether to bind the palm to the current instant messaging account. After confirmation, the user binds the palm to the instant messaging account. After the binding is completed, the user is further asked to confirm whether to allow human face information to be bound to the palm for subsequent more secure recognition and verification. A human face does not need to be registered. Real-name authentication is needed when a user uses an instant messaging client. A face image of a current user is stored for subsequent silent recognition and comparison.

The palm scanning login module in the pay-by-palm APP continues to be described below.

In some aspects, a pay-by-palm terminal runs an applet framework, and a user performs a login in a form of palm recognition. After the user performs a login, a merchant applet has identity information of the current user, and the user may perform related operations such as purchasing and payment. However, a login scenario easily leads to insecurity of user information. For example, when a user forgets to log out, the information is prone to be used maliciously.

The silent face recognition module in the pay-by-palm APP continues to be described below.

In some aspects, assuming that a user is asked to keep a hand in front of a 3D palm scanning camera for a long time, silent recognition and identity confirmation may be achieved, but this has great impact on user experience, and the user needs to keep the palm suspended in the air for a long time. In view of the foregoing problem, in the technical solution provided in the aspects of this disclosure, an additional 3D face scanning camera for face recognition is added to the pay-by-palm terminal. After a user successfully performs a login, human face image information (i.e., an authorized human face image) bound to the instant messaging account is further obtained. Subsequently, the 3D face scanning camera may be invoked to perform silent face collection, to avoid interrupting a user operation. Subsequently, collected face streaming media data may be transmitted to the palm scanning back-end service for recognition.

FIG. 9 is a schematic flowchart of a login verification method for an application program according to an aspect of this disclosure. A description is to be provided based on operations shown in FIG. 9.

Operation 201: Perform silent recognition.

Operation 202: Determine whether a same person is presented, perform operation 201 if so, and perform operation 203 to operation 205 or perform operation 206 to operation 208 if not.

Operation 203: Scan a palm for verification.

Operation 204: Determine whether the verification succeeds, perform operation 205 if the verification fails, and perform operation 201 if the verification succeeds.

Operation 205: Suspend a business.

In some aspects, during silent face recognition, it is continuously determined whether the same person is presented, and the silent recognition is continued if the same person is presented. When a different person is presented, a prompt interface for palm scanning verification pops up on a pay-by-palm terminal, and the interface may further include two-dimensional code information of a palm scanning service applet. After a user performs palm scanning verification, a silent recognition process is performed if the verification succeeds. If the verification fails, the business is directly suspended. In this case, it may be determined that the person is not the user in person.

Operation 206: Display a two-dimensional code.

Operation 207: Display a waiting interface.

Operation 208: Perform state synchronization, and perform operation 201.

Herein, the performing state synchronization refers to synchronizing configuration information (for example, including a time interval and a collection frequency) set by the user on a mobile phone to the pay-by-palm terminal.

In some aspects, in some scenarios, for example, in a scenario of queuing in a supermarket, when a user has a plurality of articles, the user may often face these articles and cannot be recognized, or may be recognized as a person behind. In this case, the user may choose to appropriately reduce a frequency of silent recognition, or the user may voluntarily decide an occasion for recognition. For example, the user may previously enter an applet for configuration on the mobile phone, or by scanning a two-dimensional code on a prompt interface when facial recognition fails. After the user scans the two-dimensional code, the business on the pay-by-palm terminal enters a suspend state. After the user operates on the mobile phone, configuration information related to new silent face recognition is pulled, and a business process is started again.

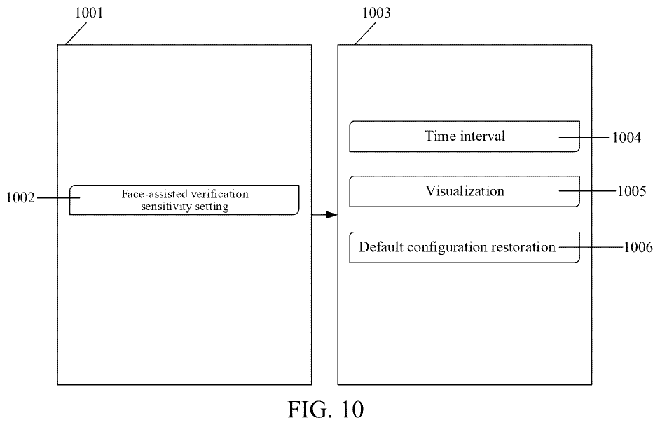

FIG. 10 is a schematic diagram of an application scenario of a login verification method for an application program according to an aspect of this disclosure. As shown in FIG. 10, after a user scans a two-dimensional code displayed on a pay-by-palm terminal through a mobile phone, the user may enter a palm scanning service applet, to display a corresponding applet interface 1001 on the mobile phone. A “face-assisted verification sensitivity setting” button 1002 is displayed on the applet interface 1001. After entering the palm scanning service applet, the user may perform settings by clicking/tapping the face-assisted verification sensitivity setting button. For example, when a clicking/tapping operation performed by the user for the “face-assisted verification sensitivity setting” button 1002 is received, a sensitivity setting interface 1003 may be displayed. A “time interval” button 1004, a “visualization” button 1005, and a “default configuration restoration” button 1006 are displayed on the sensitivity setting interface 1003. The user may set a time interval for performing face recognition by the pay-by-palm terminal through the “time interval” button 1004, i.e., the time interval is a recognition interval set by the user. After the user sets the time interval, the pay-by-palm terminal periodically enables silent face recognition based on the time interval currently set by the user. The “visualization” button 1005 is configured to provide a floating window interface on the pay-by-palm terminal, so as to display a time interval between a current moment and a next time for face recognition, so that the user can prepare for silent recognition and verification in advance. The “default configuration restoration” button 1006 is configured to quickly restore to a default silent recognition state when the user feels that a problem exists.

The process control module in the pay-by-palm APP continues to be described below.

In some aspects, when silent face recognition results are consistent, no response exists. When a human face changes, or a human face state changes, for example, the human face disappears, a capability of logging out by scanning a palm is invoked, to eliminate the login state, thereby ensuring security of user information.

The payment result page module in the pay-by-palm APP continues to be described below.

In some aspects, the payment result page module is configured to display a related payment result. For example, after the user performs an operation of exiting the applet, a related payment result is displayed through the payment result page module, for example, a payment success or a payment failure.

The palm scanning back-end service shown in FIG. 8 continues to be described below.

In some aspects, the palm scanning back-end service mainly includes a face recognition service, a palm recognition service, an applet service, and a payment service. The face/palm recognition service is mainly configured to receive a face/palm image uploaded by the pay-by-palm terminal and then perform feature extraction on a current image, compare the extracted face/palm feature with an authorized face/palm feature in a database, and find an authorized face/palm feature with a highest score, thereby obtaining identity information of the user. After successful comparison, i.e., after user identity is successfully matched, payment information, such as a payment code, may be returned to the pay-by-palm terminal. The applet service is mainly configured for a user to obtain a specific applet login state of the user through palm scanning recognition, and then log in to an applet run on the pay-by-palm terminal. The payment service is a back-end service used by a merchant to initiate payment to a payment backend after obtaining a payment code.

According to the login verification method for an application program provided in the aspects of this disclosure, the user is advised to bind information related to a human face at the same time when registering with a palm scanning application. When the user subsequently logs into a related application through palm scanning offline, the human face may be used for silent recognition based on a fact that the human face is positioned in front of a device for a relatively long period of time, to determine whether a same person is presented to ensure information security of the user.

An example structure of the login verification apparatus 555 for an application program provided in the aspects of this disclosure implemented as a software module is further described below. In some aspects, as shown in FIG. 2, software modules in the login verification apparatus 555 for an application program stored in the memory 550 may include a collection module 5551, a display module 5552, and a control module 5553.

The collection module 5551 is configured to perform a collection operation for a biological feature of a first type, to obtain a first collection result. The display module 5552 is configured to display an application interface in a login state in response to the first collection result including a first biological feature and a binding relationship existing between the first biological feature and a first account, the login state being a state in which a login is performed for the application program based on the first account. The collection module 5551 is further configured to perform a collection operation for a biological feature of a second type, to obtain a second collection result, the second type being different from the first type. The control module 5553 is configured to control the login state of the application interface based on the second collection result.

In some aspects, the control module 5553 is further configured to control, in response to the second collection result including a second biological feature and a binding relationship existing between the second biological feature and the first account, the application interface to maintain the login state.

In some aspects, the control module 5553 is further configured to switch the application interface from the login state to a non-login state in response to the second collection result including the second biological feature and no binding relationship existing between the second biological feature and the first account, the non-login state being a state in which a login is not performed for the application program based on the first account.

In some aspects, the display module 5552 is further configured to display prompt information in response to the second collection result including the second biological feature and no binding relationship existing between the second biological feature and the first account, the prompt information being configured for prompting that verification needs to be performed based on the biological feature of the first type. The collection module 5551 is further configured to perform the collection operation for the biological feature of the first type again, to obtain a third collection result. The control module 5553 is further configured to determine, in response to the third collection result not including the first biological feature, that the verification fails, and switch the application interface from the login state to the non-login state.

In some aspects, the control module 5553 is further configured to determine, in response to the third collection result including the first biological feature, that the verification succeeds, and control the application interface to maintain the login state.

In some aspects, the display module 5552 is further configured to display a graphic code. The login verification apparatus 555 for an application program further includes an adjustment module 5554, configured to receive configuration information transmitted by a second electronic device after scanning the graphic code, and perform one of the following processes based on the configuration information: adjusting a frequency at which the collection operation is performed for the biological feature of the second type; displaying a time interval between a current moment and a next time for performing the collection operation for the biological feature of the second type; and restoring the frequency at which the collection operation is performed for the biological feature of the second type to a default frequency.

In some aspects, the control module 5553 is further configured to: suspend a business process on the application interface in response to the graphic code being scanned; and restore the business process on the application interface in response to the configuration information transmitted by the second electronic device having been received.

In some aspects, the graphic code includes an identifier of the first electronic device, which is configured for the second electronic device to perform the following processing: displaying a setting interface corresponding to the first electronic device based on the identifier, the setting interface including a sensitivity setting control; and displaying a sensitivity setting interface in response to a trigger operation for the sensitivity setting control, the sensitivity setting interface including at least one of the following controls: a time interval control, configured to adjust a frequency at which the first electronic device performs the collection operation for the biological feature of the second type; a visualization control, configured to display, in the first electronic device, a time interval between a current moment and a next time for performing the collection operation for the biological feature of the second type; and a default configuration restoring control, configured to restore, to the default frequency, the frequency at which the first electronic device performs the collection operation for the biological feature of the second type.

In some aspects, the login verification apparatus 555 for an application program further includes an obtaining module 5555, configured to obtain a first distance and a second distance, the first distance being a distance between a living body corresponding to the first biological feature and the first electronic device, and the second distance being a distance between a living body corresponding to the second biological feature and the first electronic device. The collection module 5551 is further configured to perform the collection operation for the biological feature of the second type again in response to a difference between the second distance and the first distance being greater than a difference threshold.

In some aspects, the login verification apparatus 555 for an application program further includes a determination module 5556, configured to determine, in response to a biological feature protection function in the second electronic device being in an enabled state, that the collection operation for the biological feature of the second type is to be performed, the biological feature protection function being configured for controlling the login state of the application interface based on the biological feature of the second type.

In some aspects, the control module 5553 is further configured to switch the application interface from the login state to a non-login state in response to the second collection result not including a second biological feature, the non-login state being a state in which a login is not performed for the application program based on the first account.

In some aspects, the determination module 5556 is further configured to determine a similarity between the first biological feature and each of a plurality of authorized biological features of the first type; and query, in response to a maximum similarity being greater than a similarity threshold, for an account to which the maximum similarity corresponds and the authorized biological feature is bound, to serve as the first account.

In some aspects, the collection module 5551 is further configured to perform one of the following processes: periodically performing the collection operation for the biological feature of the second type; performing the collection operation for the biological feature of the second type in response to a non-operation duration being greater than a duration threshold; and performing the collection operation for the biological feature of the second type in response to performing of a specific operation on the application interface.

In some aspects, the collection module 5551 is further configured to perform one of the following processes: performing the collection operation for the biological feature of the first type in response to a trigger operation for a login entry in the first electronic device; periodically performing the collection operation for the biological feature of the first type; performing the collection operation for the biological feature of the first type in response to the first electronic device entering a screen-on state from a screen-off state; and performing the collection operation for the biological feature of the first type in response to the living body being detected and a distance between the living body and the first electronic device being less than a distance threshold.

In some aspects, the control module 5553 is further configured to control the application interface to be in a silent mode, the silent mode being configured for shielding an output of a prompt related to the collection operation for the biological feature of the second type. The collection module 5551 is further configured to perform the collection operation for the biological feature of the second type based on the silent mode.

In some aspects, the first account is an account associated with a first living body. The collection module 5551 is further configured to collect the biological feature of the first type and the biological feature of the second type of the first living body in advance. The login verification apparatus 555 for an application program further includes a binding module 5557, configured to bind the biological feature of the first type and the biological feature of the second type of the first living body to the first account.

In some aspects, the first biological feature is one of a palm print feature and a facial feature, and the second biological feature is the other of the palm print feature and the facial feature.

In some aspects, the application interface is an interface involving specific information in the application program.

The description of the apparatus in the aspects of this disclosure can be similar to the description of the foregoing method aspect, and can have similar beneficial effects as the method aspect. Therefore, details are not described. The technical details that are not covered in the login verification apparatus for an application program provided in the aspects of this disclosure may be understood according to the description of any one of FIG. 3, FIG. 4, or FIG. 5, as examples.

An aspect of this disclosure provides a computer program product, the computer program product including a computer program or a computer-executable instruction, the computer program or the computer-executable instruction being stored in a computer-readable storage medium. A processor of a computer device reads the computer-executable instruction from the computer-readable storage medium. The processor executes the computer-executable instruction, so that the computer device performs the login verification method for an application program provided in the aspects of this disclosure.

An aspect of this disclosure provides a computer-readable storage medium, having a computer-executable instruction stored therein, the computer-executable instruction, when executed by a processor, causing the processor to perform the login verification method for an application program provided in the aspects of this disclosure, for example, the login verification method for an application program shown in FIG. 3, FIG. 4, or FIG. 5.

In some aspects, the computer-readable storage medium such as a non-transitory computer-readable storage medium may be a memory such as a ferromagnetic RAM (FRAM), a ROM (ROM), a programmable ROM (PROM), an erasable PROM (EPROM), an electrically EPROM (EEPROM), a flash memory, a magnetic surface memory, a compact disc, or a compact disc ROM (CD-ROM), or may be various devices including one or any combination of the foregoing memories.

In some aspects, the executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units suitable for use in a computing environment.

In an example, the executable instruction may be deployed to be executed on one electronic device, or executed on a plurality of electronic devices located at one location, or executed on a plurality of electronic devices distributed at a plurality of locations and connected through a communication network.

The foregoing descriptions are merely some examples of aspects of this disclosure and are not intended to limit the scope of this application. Any modification, equivalent replacement, or improvement made within the spirit and principle of this application falls within the scope of this application.

What is claimed is:

1. A login verification method for an application program, the method comprising:
collecting a first biological feature of a first type of biological feature to obtain a first collection result;
displaying an application interface in a login state based on the first collection result including the first biological feature being associated with a first account, the application program being logged in based on the first account in the login state;
collecting a second biological feature of a second type of biological feature to obtain a second collection result, the second type of biological feature being different from the first type of biological feature; and
controlling, by processing circuitry of a first electronic device, the login state of the application interface based on the second collection result.

2. The method according to claim 1, wherein the controlling the login state comprises:
based on the second collection result including the second biological feature being associated with the first account, maintaining the application interface in the login state.

3. The method according to claim 1, wherein the controlling the login state comprises:
based on the second collection result including the second biological feature not being associated with the first account, switching the application interface from the login state to a non-login state in which the application program is not logged in based on the first account.

4. The method according to claim 3, wherein the switching the application interface comprises:
displaying prompt information based on the second collection result including the second biological feature not being bound to the first account, the prompt information indicating that verification is required based on the first biological feature of the first type;
collecting a third biological feature of the first type to obtain a third collection result; and
when the third collection result does not include the first biological feature, switching the application interface from the login state to the non-login state.

5. The method according to claim 4, wherein the controlling the login state comprises:
when the third collection result includes the first biological feature, maintaining the application interface in the login state.

6. The method according to claim 1, further comprising:
displaying a graphic code by the processing circuitry of the first electronic device;
receiving configuration information from a second electronic device after the second electronic device scans the graphic code; and
performing, by the processing circuitry of the first electronic device, based on the configuration information, at least one of:
adjusting a frequency at which the second type of biological feature is collected;
displaying a time interval between a current time and a next time for collecting the second type of biological feature; or
restoring the frequency at which the second type of biological feature is collected to a default frequency.

7. The method according to claim 6, further comprising:
suspending, by the processing circuitry of the first electronic device, an application workflow on the application interface when the graphic code is scanned; and
restoring the application workflow on the application interface when the configuration information is received from the second electronic device.

8. The method according to claim 6, wherein the graphic code includes an identifier of the first electronic device, and causes the second electronic device to:
display a setting interface corresponding to the first electronic device based on the identifier, the setting interface including a sensitivity setting control; and
display a sensitivity setting interface based on a trigger operation for the sensitivity setting control, the sensitivity setting interface including at least one of:
a time interval control element that is configured to adjust the frequency at which the first electronic device collects the second type of biological feature;
a visualization control element that is configured to cause the time interval between the current time and the next time for collecting the second type of biological feature to be displayed on the first electronic device; and
a default configuration restoring control element that is configured to restore the frequency for collecting the second type of biological feature to the default frequency.

9. The method according to claim 1, further comprising:
obtaining a first distance between a first user corresponding to the first biological feature and the first electronic device, and a second distance between a second user corresponding to the second biological feature and the first electronic device; and
collecting a fourth biological feature of the second type when a difference between the second distance and the first distance exceeds a difference threshold.

10. The method according to claim 1, further comprising:
determining, based on a biological feature protection function on a second electronic device being enabled, that the second biological feature is to be collected, the biological feature protection function being configured to control the login state of the application interface based on the second biological feature of the second type.

11. The method according to claim 1, wherein the controlling the login state of the application interface comprises:
when the second collection result including the second biological feature is not associated with the first account, switching the application interface from the login state to a non-login state in which the application program is not logged in based on the first account.

12. The method according to claim 1, further comprising:
determining a similarity between the first biological feature and each of a plurality of reference biological features of the first type; and
when a maximum similarity is greater than a similarity threshold, identifying an account bound to an authorized biological feature associated with the maximum similarity as the first account.

13. The method according to claim 1, further comprising:
performing at least one of:
periodically collecting the second type of biological feature;
collecting the second type of biological feature when a non-operation duration exceeds a duration threshold; or
collecting the second type of biological feature when a specific operation on the application interface is detected.

14. The method according to claim 1, wherein the collecting the second biological feature further comprises:
enabling a silent mode on the application interface related to collecting the second biological feature; and
collecting the second biological feature in the silent mode.

15. The method according to claim 1, further comprising:
obtaining operation data in a current time period and operation data in a previous time period;
extracting operation features from the operation data in the current time period and the operation data in the previous time period;
obtaining, via a machine learning model, a prediction result based on the operation features; and
when the prediction result indicates that a different user is present, collecting the second biological feature.

16. The method according to claim 1, further comprising:
collecting the first biological feature and the second biological feature for a first user; and
binding the first biological feature and the second biological feature to the first account, wherein the first account is associated with the first user.

17. The method according to claim 1, wherein
the first biological feature is one of a palm print feature and a facial feature, and the second biological feature is the other one of the palm print feature and the facial feature.

18. The method according to claim 1, wherein the application interface is configured to authenticate a user to perform a function.

19. A login verification apparatus for an application program, the apparatus comprising:
processing circuitry configured to:
collect a first biological feature of a first type of biological feature to obtain a first collection result;
display an application interface in a login state based on the first collection result including the first biological feature being associated with a first account, the application program being logged in based on the first account in the login state;
collect a second biological feature of a second type of biological feature to obtain a second collection result, the second type of biological feature being different from the first type of biological feature; and
control the login state of the application interface based on the second collection result.

20. A non-transitory computer-readable storage medium storing instructions which, when executed by a processor, cause the processor to perform:
collecting a first biological feature of a first type of biological feature to obtain a first collection result;
displaying an application interface in a login state based on the first collection result including the first biological feature being associated with a first account, an application program being logged in based on the first account in the login state;
collecting a second biological feature of a second type of biological feature to obtain a second collection result, the second type of biological feature being different from the first type of biological feature; and
controlling the login state of the application interface based on the second collection result.
